(19) United States
(12) Patent Application Publication
(10) Pub. No.: US 2019/0232918 A1
(43) Pub. Date: Aug. 1, 2019

(54) METHOD FOR OPERATING A SECURITY DEVICE

(71) Applicant: Robert Bosch GmbH, Stuttgart (DE)

(72) Inventors: Bjoern Kupka, Kornwestheim (DE); Pascal Grieb, Pforzheim (DE)

(21) Appl. No.: 16/316,672

(22) PCT Filed: May 23, 2017
(86) PCT No.: PCT/EP2017/062400

§ 371 Date: Jan. 10, 2019

(30) Foreign Application Priority Data
Jul. 14, 2016 (DE) 10 2016 212 898.1

(51) Int. Cl. B60R 25/102; B60L 53/66; B60L 53/65; B60L 53/68; B60R 25/01; H04L 29/08; G08B 25/00

(52) U.S. Cl. CPC B60R 25/102; B60L 53/66; B60L 53/65; B60L 53/68; B60R 25/01; B60K 6/22; G08B 25/00; B60L 2240/62; B60L 2240/70; B60L 2270/36; H04L 67/12

(57) ABSTRACT

The present invention relates to a method for operating a security device, wherein the security device is part of a charging device for charging an energy store of a vehicle, preferably an electric vehicle or hybrid vehicle. The security device is connected to an Internet-capable server. In a first step of the method, the security device reads the vehicle service data. In a second step of the method, the security device compares the vehicle service data via the server with a database of vehicles which have been reported stolen. Finally, the security device sends a signal to the charging device if the vehicle is entered as stolen in the database.

### BACKGROUND OF THE INVENTION

The present invention relates to a method for operating a safety device, wherein the safety device is part of a charging device for charging an energy store of a vehicle.

Electric vehicles typically have an electrical energy store, such as a traction battery, which provides the electric energy for powering the vehicle. If this electric energy store is wholly or partially discharged, the electric vehicle must visit a charging station, at which the energy store can be recharged. To date this is usually done at such a charging station by connecting the electric vehicle to the charging station by means of a cable connection. A disadvantageous of this is the fact that this connection must usually be made manually by a user. Another requirement is that the electric vehicle and the charging station must have matching connection systems.

In addition, isolated cases of wireless charging systems for electric vehicles are known. In inductive charging of electric vehicles, one or more coils (transmitter coils) are installed in or on the ground. In addition, one or more coils (receiver coils) are also arranged in the electric vehicle. When an electric vehicle is parked above the transmitter coil, the latter emits an alternating magnetic field. The alternating magnetic field is detected by the receiver coil within the vehicle and converted into electrical energy. By means of this electrical energy, a traction battery of the vehicle can then be charged by the contactless transfer of energy. Furthermore, the energy store of the electric vehicle can also be used for energy recovery. This can be performed using a cable connection or else an inductive power transfer.

Document DE102011010049 A1 discloses such a system for charging a vehicle battery, in which the energy is transferred inductively. A disadvantage of the prior art is the fact that both the wired and the wireless charging procedures are only be used to recharge traction batteries of the respective vehicle. Some methods include additional functionalities, such as billing procedures, by means of which the amount of charge supplied to the battery can be billed to the driver. Disadvantageously, in the prior art it does not matter for the charging process whether the vehicle has been stolen and is being charged by the vehicle thief, or is being charged by the real vehicle owner or by an authorized driver. An authorized driver as well as a non-authorized driver can both charge the vehicle at a charging column or a power source without being prevented from doing so. In addition, the authorities such as the police are not supported in the investigation of vehicle thefts.

There is therefore a need for a procedure by which the theft of a vehicle can be made more difficult and/or more efficiently detected.

### SUMMARY OF THE INVENTION

The method according to the invention has the advantages that vehicle thefts are made more difficult and/or authorities such as the police are supported in the investigation of vehicle thefts.

According to the invention a method for operating a safety device is provided, wherein the safety device is part of a charging device for charging an energy store of a vehicle, preferably an electric or hybrid vehicle. The safety device is connected to an internet-enabled server. In a first step of the method the safety device reads out the service data from the vehicle. In a second step of the method the safety device compares the vehicle service data via the server with a database of vehicles reported stolen. Finally, the safety device sends a signal to the charging device if the vehicle is registered as stolen in the database. The advantage of this method is that the theft of vehicles by car thieves is made more difficult. In addition, the authorities (e.g. the police) are supported in the investigation of vehicle theft.

Advantageously, the charging device is arranged in the vehicle. This is advantageous to the extent that, regardless of the charging points of the infrastructure (charging columns in the parking garage, at the side of the road, etc.), every vehicle itself carries the safety device fitted with the charger. Therefore, using the charging device or security device the vehicle is itself able to test the status of the vehicle (stolen, not stolen), without having to be dependent on whether or not, for example, an external charging column is capable of doing so.

A further advantage is the fact that the charging device is arranged in a charging column outside the vehicle. Arranging the charging device in an external charging column rather than installing it in every vehicle in advance advantageously reduces the purchasing costs for the driver.

Advantageously, on receipt of the signal by the safety device, the charging device either does not start or ceases the charging process of the energy store. If the safety device determines that the vehicle has been reported stolen and is thus listed in the database of vehicles reported stolen, it sends an appropriate signal to the charging device. If the charging operation has already begun, this is advantageously ceased. If, for example, the energy store of the vehicle only has a low level of charge then no further charge can be drawn, as a result of which the vehicle's range is significantly limited and it can be more easily found, for example by the police. Alternatively, the charging process is not even started, so that the energy store of the vehicle also remains empty, which also results in a limited range and a more effective access by the police.

Advantageously, on receipt of the signal by the safety device, the charging device starts the charging process fictitiously. A message is displayed to the driver indicating that the energy store is charged, i.e. that the charging process is active but without it really being charged (fictitious charging operation). Therefore, if the driver waits for the completion of the charging process, in the event of notification of the location of the vehicle, the police have more time to get to the location of the vehicle and secure the vehicle, and possibly also apprehend the thief of the vehicle.

A further advantage is the fact that upon receipt of the signal by the safety device the charging device discharges the energy store. Instead of charging up the energy store (e.g. a traction battery/battery), the energy store is completely discharged. The vehicle is therefore no longer in a position to leave the current location, allowing the police to trace the vehicle more easily.

Upon receipt of the signal by the safety device, the charging device advantageously activates an engine immobilizer system. Even if the actual energy store is still sufficiently charged to travel a certain distance, the vehicle can no longer be moved due to the engine immobilizer being activated.

A further advantage is the fact that upon receipt of the signal by the safety device, the charging device sends the location and the vehicle service data of the vehicle to the police. In the case that the vehicle is registered as stolen, the police are thus informed as to which vehicle (type, color, license plate, etc.) they must look for and where the vehicle is exactly located. The location is advantageously transmitted in the form of GPS data.

Further features and advantages of the present invention will be apparent to a person skilled in the art from the following description of exemplary embodiments, which are not to be interpreted as limiting the invention in any way, and by reference to the attached drawings.

### BRIEF DESCRIPTION OF THE DRAWINGS

Shown are:

FIG. 1: a schematic diagram of the different steps regarding the method for operating a safety device in accordance with an embodiment of the invention;

FIG. 2: a schematic representation of a cross-section of a vehicle equipped with a safety device in accordance with an embodiment of the invention;

FIG. 3: a schematic representation of a cross-section of a vehicle with a safety device, which is part of a charging device which in turn is part of a charging column in accordance with a further embodiment of the invention;

For reasons of clarity the drawings shown in the figures are not necessarily shown to scale. Identical reference numerals generally designate similar or functionally equivalent components.

### DETAILED DESCRIPTION

FIG. 1 shows a schematic representation of the method for operating a safety device 10, which is part of a charging device 11, for example, such as can be used to charge up an energy store 12 (e.g. battery or traction battery) of a vehicle 13 (preferably an electric vehicle or hybrid vehicle). The safety device 10 is connected to a server 14, which is advantageously connected to the internet or can obtain information over the internet. The safety device 10 has access via the server 14 to a database 15, in which vehicles reported as stolen are listed. If the battery of the vehicle 13 needs to be charged, the driver drives the vehicle 13 to a charging point. There the vehicle can be charged either by cable or wirelessly (inductively). The charging device 11 is located either in the vehicle 13 or is part of a charging column 16. Regardless of the location of the charging device 11 (in the vehicle 13 or in the charging column 16), the safety device 10 of the charging device 11 first reads the vehicle service data in a first step A. These include, for example, vehicle type, vehicle color, license plate and the like. In a second step B the safety device 10 communicates with the server 14. In this process the vehicle service data are compared against a database 15, in which vehicles reported as stolen are listed. If it is discovered that the vehicle 13 has been reported stolen or is registered as stolen, in a third step C the safety device 10 sends a signal to the charging device 11. The charging device 11 then initiates one, a plurality or all of the following steps.

If the charging process of the traction battery 12 has already begun and it is subsequently discovered that the vehicle 13 has been stolen, the charging device 11 interrupts the charging process. Alternatively—if the charging process has not yet been initiated—if the status of the vehicle 13 is discovered to be stolen the traction battery is not charged at all.

In addition, the charging device 11 can indicate to the driver, who is also suspected of being the vehicle thief, that the charging of the traction battery 12 has begun, although it is not actually being charged. Thus, it is only fictitiously charged by a charging operation merely being simulated. To detain the vehicle 13 permanently at the current location, the charging device 11 initiates the complete discharging of the vehicle battery 12. Without the presence of charge, the vehicle 13 can no longer be moved by electric means. Since only fully electric-powered vehicles 13 (so-called electric vehicles) can therefore no longer be driven, but hybrid vehicles are still able to be driven due to the presence of an internal combustion engine (even without battery charge), the charging device 11 activates the immobilizer 17. This means that regardless of the vehicle type (electric or hybrid vehicle) and state of charge of the battery 12 (partially charged or fully discharged), the vehicle 13 can no longer be moved. In order to facilitate the task of the authorities such as the police to trace the vehicle and possibly also apprehend the vehicle thief, the charging device 11 sends the vehicle service data and the location of the vehicle 13 to the police. The location of the vehicle 13 is advantageously determined via GPS and transmitted in the form of GPS coordinates. In addition, further information such as date, time, etc. can also be transmitted. The charging device 11 also continuously or repeatedly transmits the GPS coordinates to the police and/or appropriate alternative authorities. If the driver is nevertheless in a position to move the vehicle 13 (failure of the engine immobilizer 15 or by means of the internal combustion engine), the police can therefore locate and track the vehicle 13.

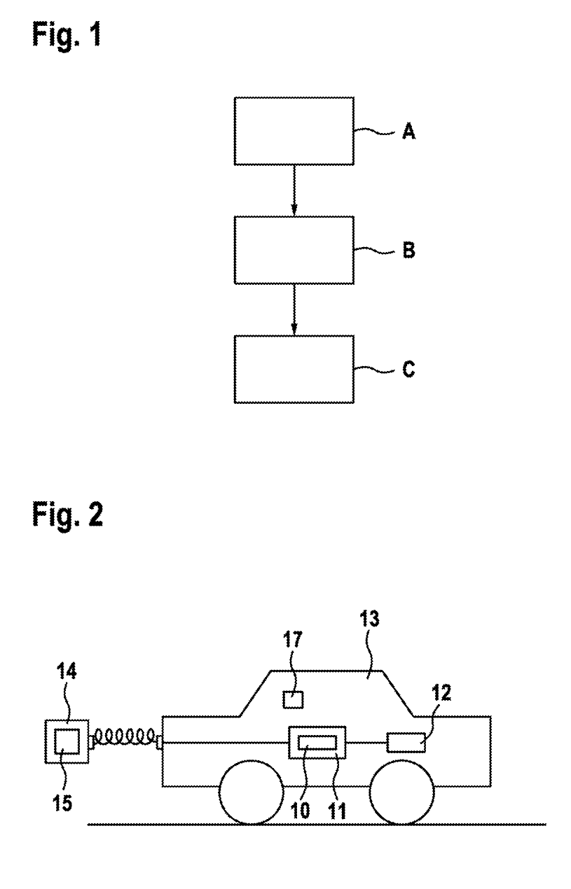

FIG. 2 shows a schematic representation of a cross-section of a vehicle 13 equipped with a safety device 10 in accordance with an embodiment of the invention. Equivalent elements to those in FIG. 1 are assigned the same reference numerals and will not be described in further detail. The vehicle 13 has a safety device 10, which is part of a charging device 11. The charging device 11 charges the energy store 12 of the vehicle 13, wherein the energy store 12 is a traction battery or vehicle battery (battery). The vehicle 13 can be a pure electric vehicle, but can also be embodied as a hybrid vehicle and have an internal combustion engine. Using the charging device 11 the traction battery 12 can optionally be charged by means of a wired or an inductive charging method.

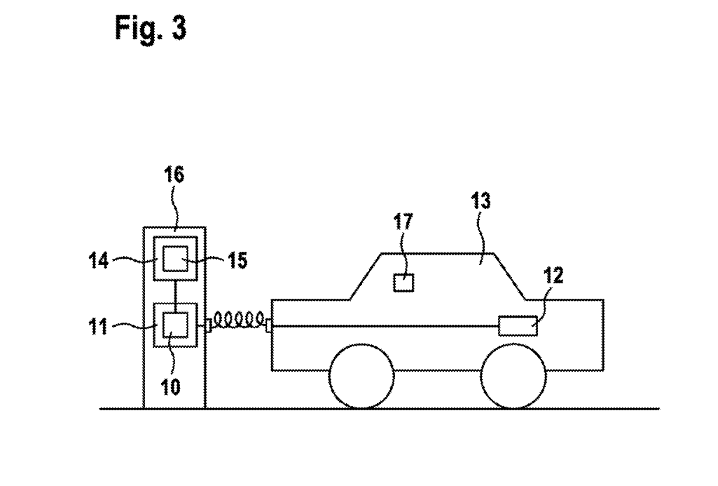

FIG. 3 shows a schematic representation of a cross-section of a vehicle 13 with a safety device 10, which is part of a charging device 11, which in turn is part of a charging column 16 according to a further embodiment of the invention. The same elements in relation to FIGS. 1 and 2 are labelled with the same reference numerals and are not explained further. The safety device 10 in this exemplary embodiment is part of a charging device 11, wherein the charging device 11 is again part of a charging column 16. The charging device 11 charges the energy store 12 of the vehicle 13, wherein the energy store 12 is a traction battery or vehicle battery (battery). The vehicle 13 can be a pure electric vehicle, but can also be embodied as a hybrid vehicle and have an internal combustion engine. The charging column 16 can be connected to the vehicle 13 via a cable and thus charge up the traction battery 12 via a cable or can operate an inductive energy transfer device (not shown here), which has a transmitter coil (located in or on the ground below the vehicle 13) and a receiver coil (installed in the vehicle 13). Regardless of the charging method (by cable or inductive), the safety device 10 and charging device 11 function as described under FIG. 1.

1. A method for operating a safety device (10),
wherein the safety device (10) is part of a charging device (11) for charging an energy store (12) of a vehicle (13), wherein the safety device (10) is connected to an internet-enabled server (14), the method comprising:
reading out, via the safety device (10), vehicle service data;
comparing, via the safety device (10), the vehicle service data with a database (15) of vehicles reported stolen;
in response to determining that the vehicle (13) is recorded in the database (15) as stolen sending, via the safety device, a signal (S) to the charging device (11).

2. The method for operating a safety device (10) as claimed in claim 1,
wherein the charging device (10) is arranged in the vehicle (13).

3. The method for operating a safety device (10) as claimed in claim 1,
wherein the charging device (10) is arranged in a charging column (16) arranged outside the vehicle (13).

4. The method for operating a safety device (10) as claimed in claim 1, wherein on receipt of the signal (S) by the safety device (10), the charging device (11) either does not start or ceases the charging process of the energy store (12).

5. The method for operating a safety device (10) as claimed in claim 1, wherein on receipt of the signal (S) by the safety device (10) the charging device (11) starts the charging process fictitiously.

6. The method for operating a safety device (10) as claimed in claim 1, wherein on receipt of the signal (S) by the safety device (10), the charging device (11) discharges the energy store (12).

7. The method for operating a safety device (10) as claimed in claim 1, wherein on receipt of the signal (S) by the safety device (10), the charging device (11) activates an immobilizer system (17).

8. The method for operating a safety device (10) as claimed in claim 1, wherein on receipt of the signal (S) by the safety device (10), the charging device (11) sends the location and the vehicle service data of the vehicle (13) to a law enforcement agency.
